(19) United States
(12) Patent Application Publication
(10) Pub. No.: US 2007/0031807 A1
(43) Pub. Date: Feb. 8, 2007

(54) Content unity control method for using signal system

(76) Inventor: Jong Kyung Kim, Seoul (KR)

Correspondence Address: IP STRATEGIES, 12 1/2 WALL STREET, SUITE I, ASHEVILLE, NC, 28801, US

(21) Appl. No.: 11/479,945

(22) Filed: Jun. 30, 2006

(30) Foreign Application Priority Data
Aug. 3, 2005 (KR) 10-2005-70939

(51) Int. Cl. G09B 3/00

(52) U.S. Cl. 434/350; 434/362

(57) ABSTRACT

The present invention relates to a content unity control method for using signal system to control the unities of contents that are used through such physical support as wired or wireless internet, Mobile, PDA, DMB, PSP, etc. Particularly the present invention is intended to help the user to minimize the physical, time and space limits in using the content after going through the established authentication procedures and secure a satisfactory content service from the physical support that the user wants at any time and any place, and at the same time provide an identical and unified interface so that the unities of contents may be searched with ease, the user administration may be carried out easily, and an efficient approach to get hold of the registered data and statistics together with their utilization may be accomplished.

### FIELD OF THE INVENTION

The present invention relates to a content unity control method for using signal system to control the unities of contents that are used through the physical support of wired/wireless internet, Mobile, PDA, DMB, PSP, etc. Particularly the present invention is intended to minimize the physical, time and space limits while the user is using contents after going through the established authentication procedures and support a satisfactory content service so that the user may get the contents that he wants at any time and any place, and, at the same time, provide an identical and unified interface so that the user may accomplish content unity search and user administration with ease and also approach efficiently to the registered data statistics together with its applications.

### BACKGROUND OF THE INVENTION

The conventional system for the unity control of digital content adopted an integrative solution developed on the wired/wireless internet basis. Accordingly, in case where the user uses contents through the physical support of the conventional Mobile, PDA, DMB, PSP, etc., there were many disadvantages in the integrative control of wired/wireless internet such as the difficulty in approaching contents, the problem of one-way transfer, etc.

### SUMMARY OF THE INVENTION

The present invention is intended to overcome the disadvantages of the conventional technique. Therefore, it is an object of the present invention to modularize various index screens (initial screens) so that the design skin of index screen can be easily altered in the administrator's mode without a separate customizing, and also to enable for the administrator to alter accordingly to the institutional peculiarities in the variable, not fixed, field in case of the main category.

It is another object of the present invention to use the physical support (wired/wireless internet, Mobile, PDA, DMB, PSP, etc.) with LCMS (Learning Content Management System) and LMS (Learning Management System) installed on and connected to the personal mini homepage (blog) so that the user may use and administrate the content, thereby receiving a royal welcome from the user.

As to the content, irregardless of the physical support, a device of interface for the respective physical support is provided to heighten the accessibility to the content, and it is possible to download contents without a separate telecommunicative link in an approach through the wired/wireless internet with such a terminal device as Mobile, PDA, DMB, PSP, etc.

### BRIEF DESCRIPTION OF THE DRAWING

FIG. 1 illustrates an overall distribution diagram of wired/wireless internet according to the present invention.

FIG. 2 illustrates a client main page according to the present invention.

FIG. 3 illustrates a Mobile and ubiquitous version page according to the present invention.

FIG. 4 illustrates a blog of the web version of ULCMS for the class administration according to the present invention.

FIG. 5 illustrates a main page of PDA and WEB ULCMS according to the present invention.

FIG. 6 illustrates a Homepage Administrating Page of FIG. 5 according to the present invention.

FIG. 7 illustrates a flowchart for Menu Administration of the present invention.

FIG. 8 illustrates a flowchart for Quick Menu Administration of the invention.

FIG. 9 illustrates a flowchart for Content Administration of the present invention.

FIG. 10 illustrates a flowchart for Category Administration of FIG. 9.

FIG. 11 illustrates a flowchart for Form Administration of FIG. 9.

FIG. 12 illustrates a flowchart for Player Management of the present invention.

FIG. 13 illustrates a flowchart for Content Administration of FIG. 9.

FIG. 14 illustrates a flowchart for Search of FIG. 13 of the present invention.

FIG. 15 illustrates a flowchart for Input/Amend of FIG. 13 of the invention.

FIG. 16 illustrates a flowchart for File Extraction of FIG. 13 of the invention.

FIG. 17 illustrates a flowchart for Lecture Taking Status of FIG. 13 of the present invention.

FIG. 18 illustrates a flowchart for Series Administration of FIG. 9 of the invention.

FIG. 19 illustrates a flowchart for Membership Administration of FIG. 6.

FIG. 20 illustrates a flowchart for Bulletin Board Administration off FIG. 6.

FIG. 21 illustrates a flowchart for User Recommendation Data of FIG. 6.

FIG. 22 illustrates a flowchart for Desired Data of FIG. 6 of the present invention.

FIG. 23 illustrates a flowchart for Events of FIG. 6 of the present invention.

FIG. 24 illustrates a flowchart for News of FIG. 6 of the present invention.

FIG. 25 illustrates a flowchart for Blog of FIG. 6 of the present invention.

FIG. 26 illustrates a flowchart for Mock Test of FIG. 6 of the present invention.

FIG. 27 illustrates a flowchart for Statistics Administration of FIG. 6.

FIG. 28 illustrates a flowchart for Survey of FIG. 6 of the present invention.

FIG. 29 illustrates a flowchart for Pup-Up Window of FIG. 6 of the invention.

FIG. 30 illustrates a flowchart for Configuration Administration of FIG. 6.

FIG. 31 illustrates a flowchart for Client Page of FIG. 5 of the present invention.

FIG. 32 illustrates a flowchart for Electronic Book of FIG. 31 of the invention.

FIG. 33 illustrates a flowchart for U-Learning Content of FIG. 31.

FIG. 34 illustrates a flowchart for Learning Contents of FIG. 31 of the invention.

FIG. 35 illustrates a flowchart for Cyber Culture Center of FIG. 31.

FIG. 36 illustrates a flowchart for Community of FIG. 31 of the present invention.

FIG. 37 illustrates a flowchart for My Study Room of FIG. 31 of the invention.

FIG. 38 illustrates a flowchart for Diary of FIG. 37 of the present invention.

FIG. 39 illustrates a flowchart for Photo Album of FIG. 37 of the invention.

FIG. 40 illustrates a flowchart for Bulletin Board of FIG. 37 of the invention.

FIG. 41 illustrates a flowchart for Visitors' Book of FIG. 37 of the invention.

FIG. 42 illustrates a flowchart for My Study Room Administration of FIG. 37.

FIG. 43 illustrates a flowchart for Friends Registration and Registered Friends Management of FIG. 42 according to the present invention.

FIG. 44 illustrates a flowchart for Friends Search of FIG. 42 of the invention.

### DETAILED DESCRIPTION OF THE PREFERRED EMBODIMENT

The present invention is characteristic of the 21 steps: the 1st step for the membership application or the log-in with an authorized personal number; the 2nd step for going through a route to obtain data to use them; the 3rd step for the e-book unity search (drive in a single interface) and its use; the 4th step for connecting such physical wireless support as Mobile, PDA, DMB, PSP, etc. to the computer through the web connection in case of u-learning, downloading the content to be used, then shifting to the wireless device to use it; the 5th step for connecting through URL in such physical wireless support of itself as Mobile, PDA, DMB, PSP, etc., then to use it by getting downloading or by streaming; the 6th step for the use of data through the web in case of e-learning or cultural content; the 7th step for using the data co-existing in both e-learning and u-learning; the 8th step for the composition of the web screen and the screen of the device of such physical support of itself as Mobile, PDA, DMB, PSP, etc. and the simultaneous provision; the 9th step for the administration of the lecture notes taken by the user; the 10th step for the combination of the course administration system with the blog for the provision of a user's personal cyber study room to use it; the 11th step for showing the points accumulated according to the user's frequency of use, the user's level upgraded accordingly to the points accumulated, and the user's rank among all the users; the 12th step for the provision of the data obtained in the above 11th step for various events; the 13th step for using the community screen for the activation of the users; the 14th step for applying for the desirable data in the web; the 15th step for altering the skin of the main screen in the administrator's page without a separate customizing and modularizing various skins; the 16th step for the unity control of the contents of such physical support as wired/wireless internet, Mobile, PDA, DMB, PSP, etc.; the 17th step for developing, storing, and maintaining contents in the separate object unit so that the already developed content can be reused; the 18th step for providing adaptable contents suitable for the user's peculiarities; the 19th step for maintaining the record information on the users as an operating system for the administration of the users and the transmission of the contents; the 20th step for directly setting up a level of mock test suitable for the user; and the 21st step for loading a function of survey for the collection of necessary data.

Now an actual example of the present invention will be described with reference to the attached drawings as follows:

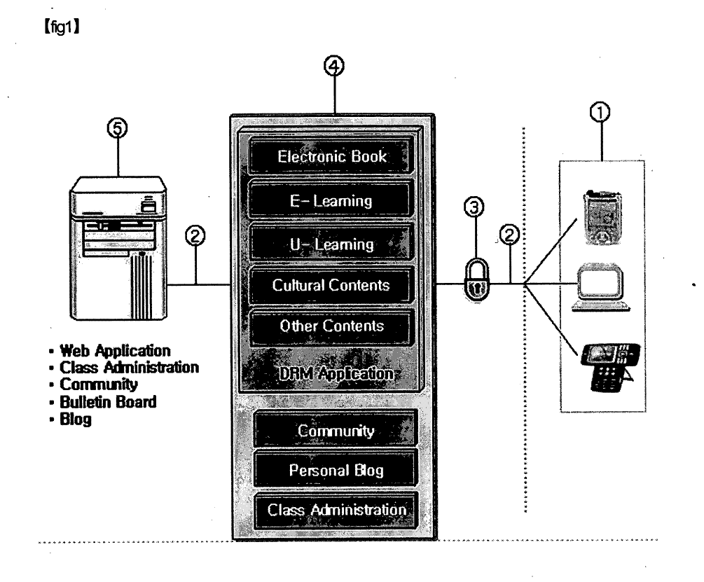

FIG. 1 illustrates an overall distribution diagram of the wired/wireless web client according to the present invention, comprising the 1st step for connecting PDA, PC, DMB, etc. of the client (1) to a telecommunication system like the internet (2), the 2nd step for going through the authentication and security system (3), and 3rd step for connecting to the digital content unity control solution (4), which is connected to the content server (5).

The above digital content unity control solution (4) includes Electronic Book, E-Learning, U-Learning, Cultural Contents, and Other Contents, and is comprised to control Community, Personal Blog, and Class Administration.

Also, the above content server (5) includes Web Application, Class Administration, Community, Bulletin Board, Blog, etc.

The above Electronic Book is designed to drive the keyword unity search and a single UI (User Interface) to search all the electronic books available in the market without reference to the publishing company. All electronic books are classified into General and Children, and the general electronic books are classified according to the KDC Classification.

The above U-Learning, in case where the content is driven in such physical support as Mobile, PDA, DMB, PSP, etc., it provides a device of interface for the respective physical support irregardless of the kind of physical support in order to heighten the accessibility to the content, and, in case where a wired/wireless internet is approached with Mobile, PDA, DMB, PSP, etc., it is comprised to download the content through USB without a separate telecommunicative link.

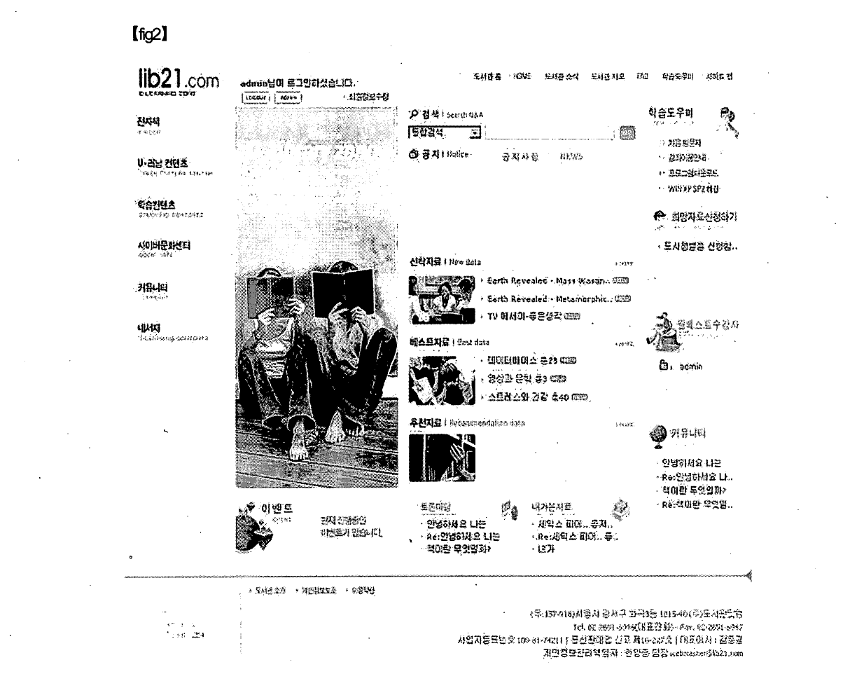

FIG. 2 illustrates a client's main page, which is comprised for the administrator to alter the skin without an extra work by providing five main UI's (User Interfaces) and the formable number of the category may increase as long as the design is not decomposed.

The above five interfaces comprises Electronic Book, U-Learning Contents, Learning Contents, Cyber Culture Center, Community, and Others.

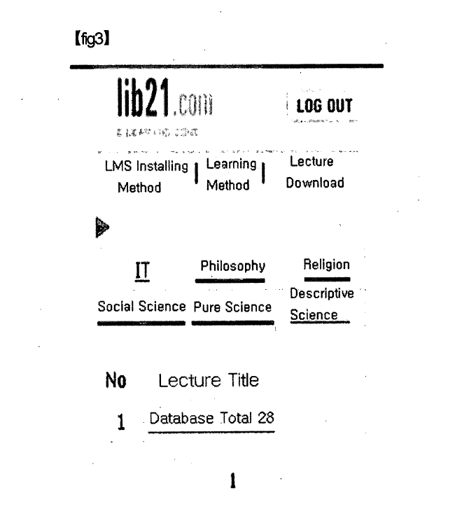

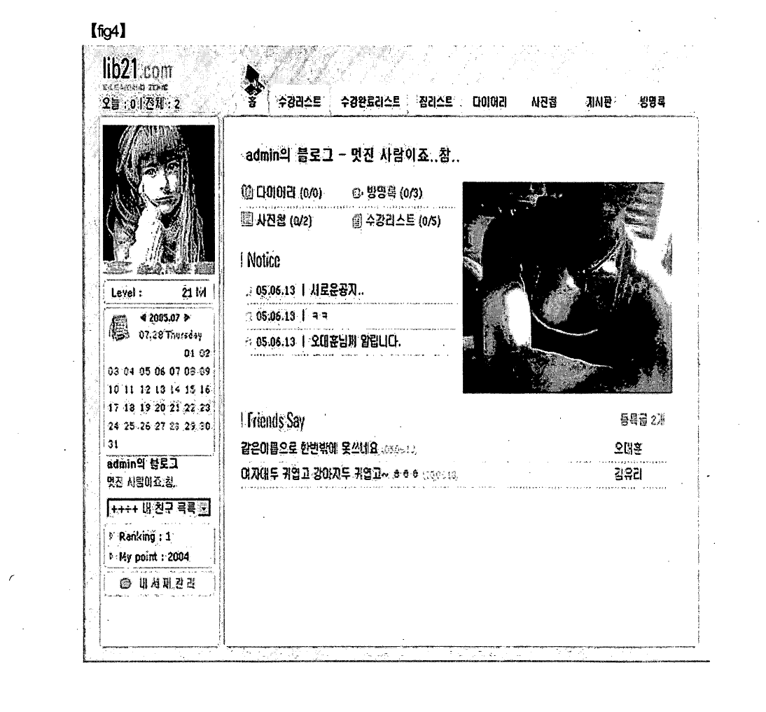

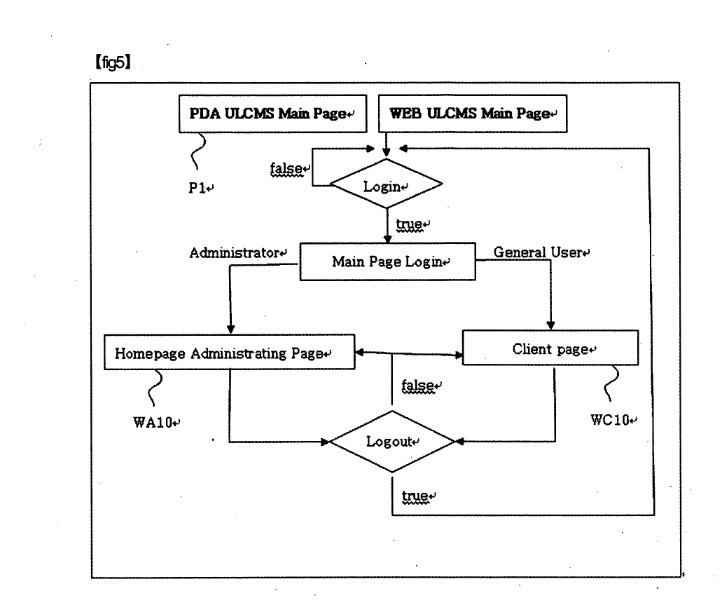

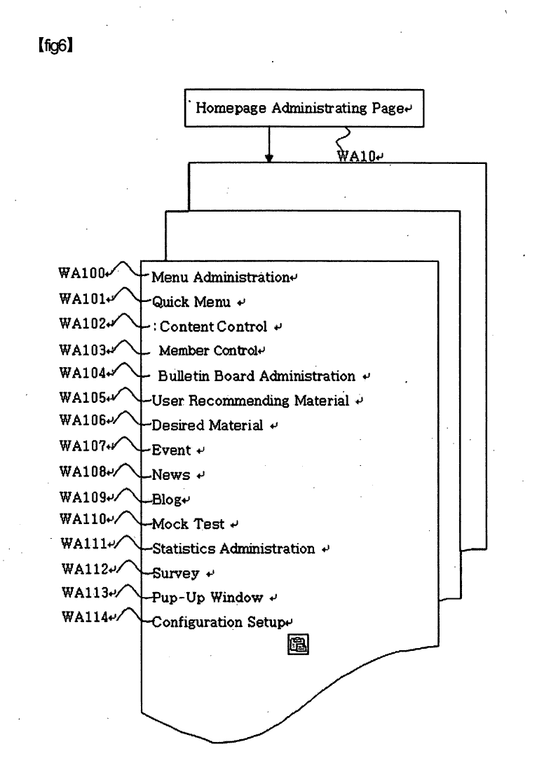

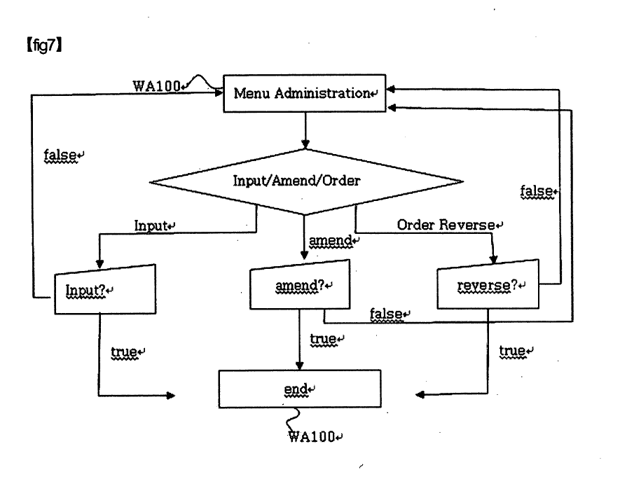

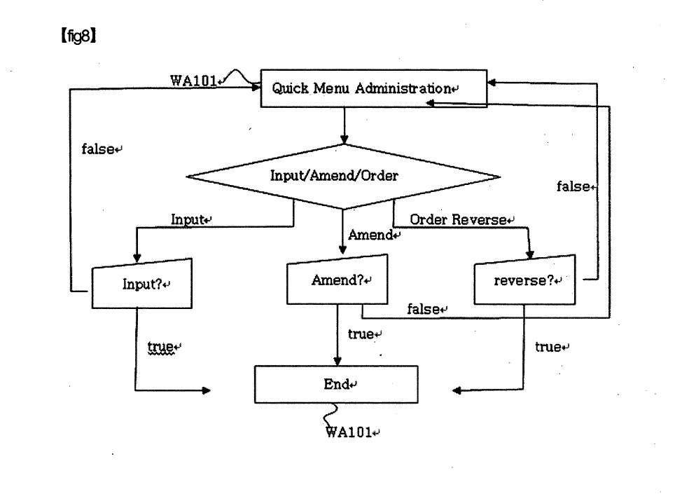

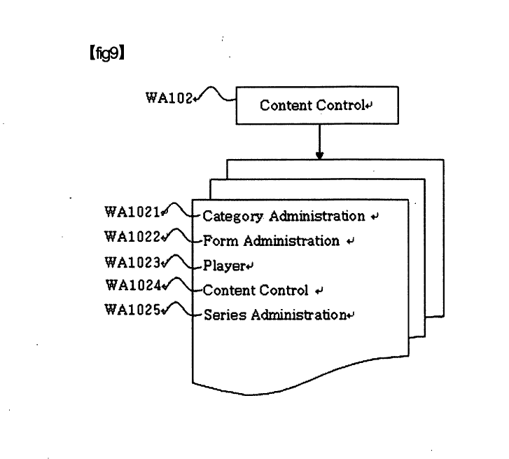

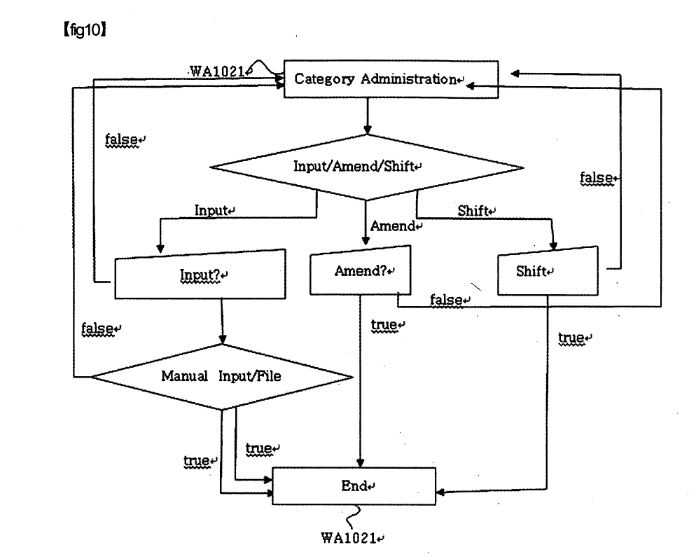

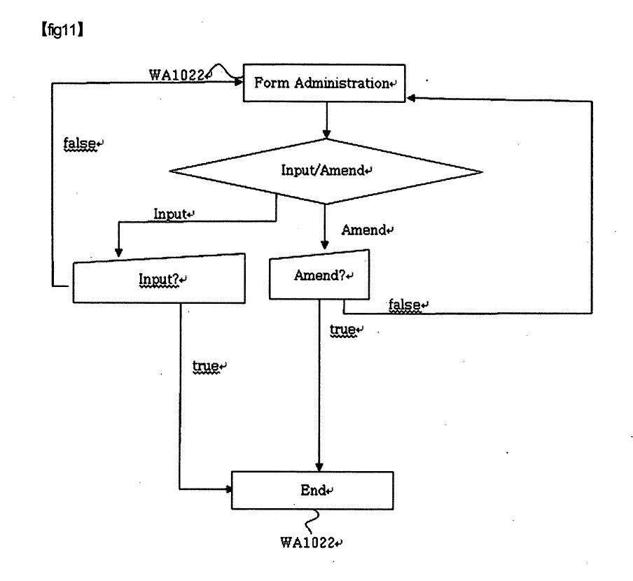

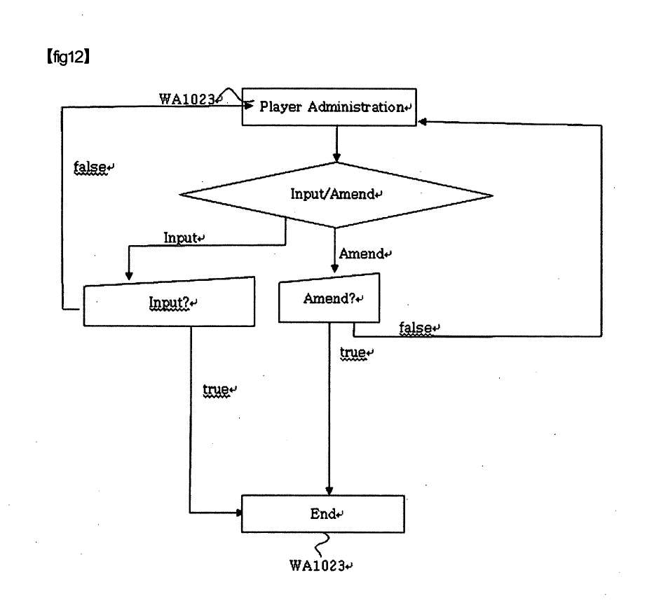

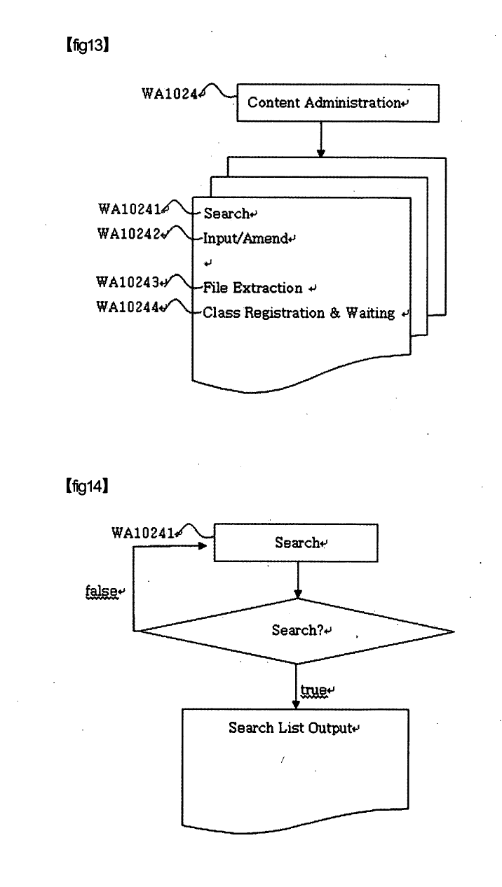

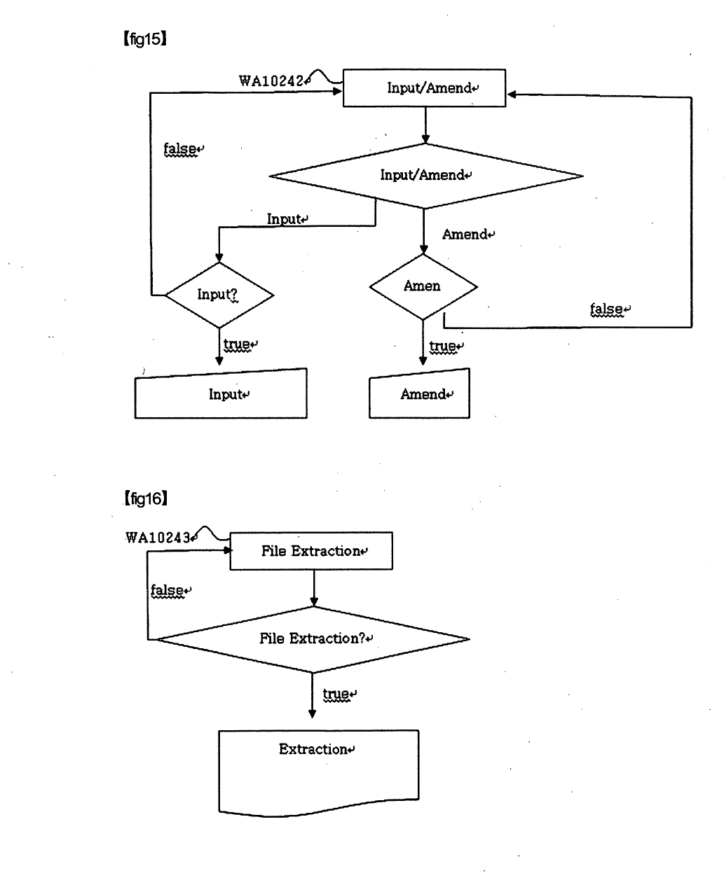

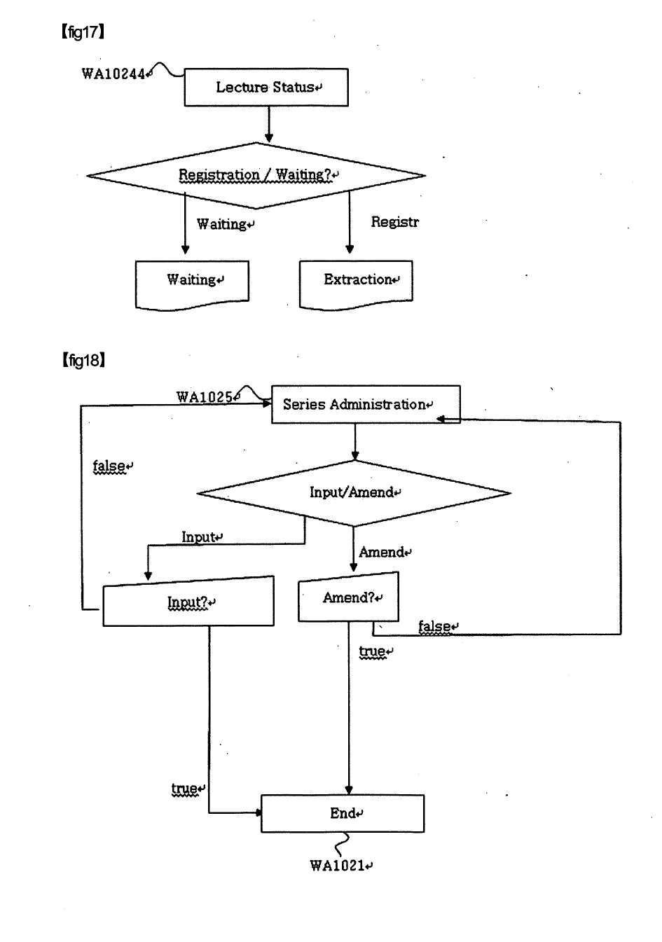

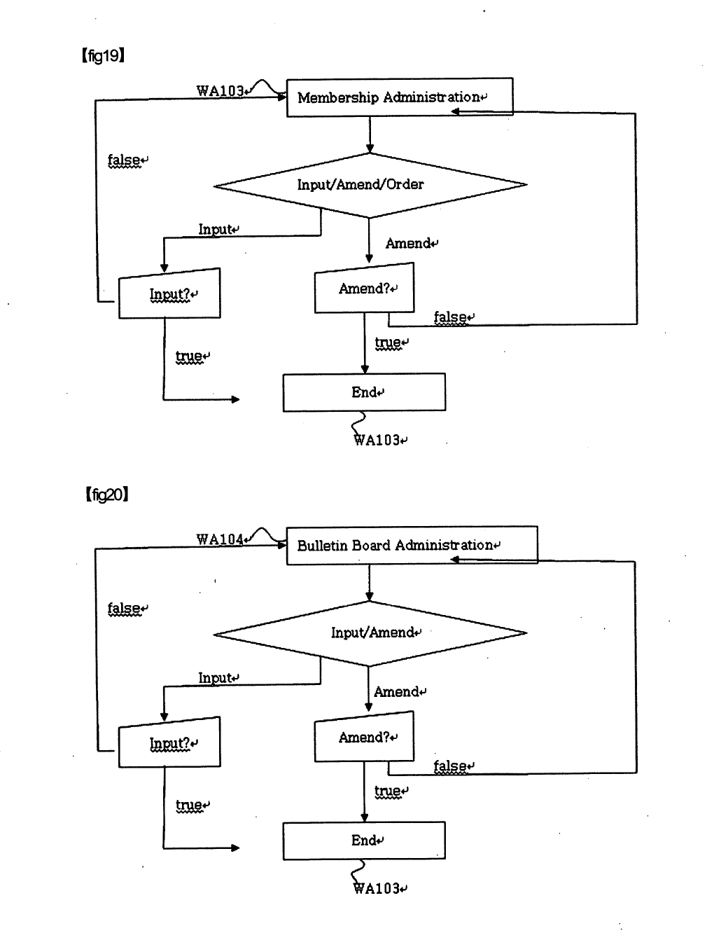

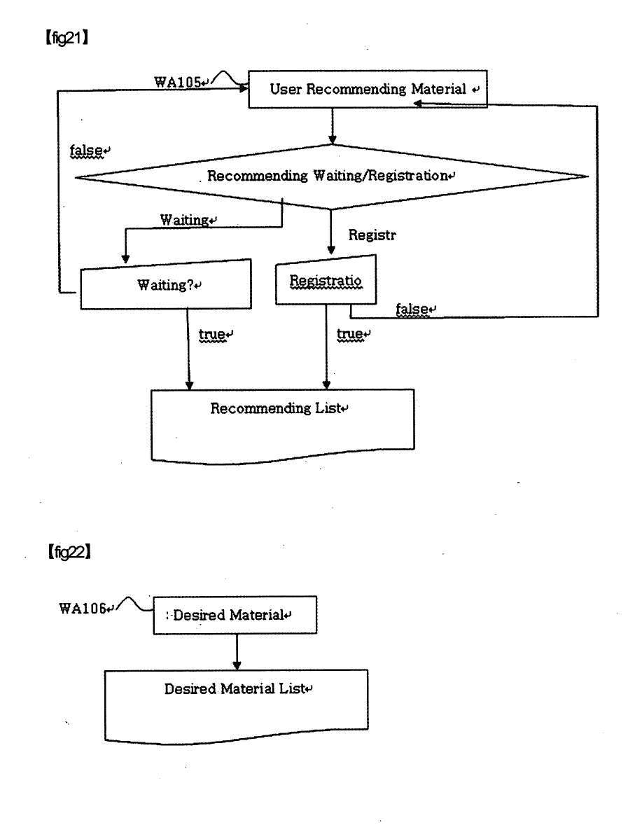

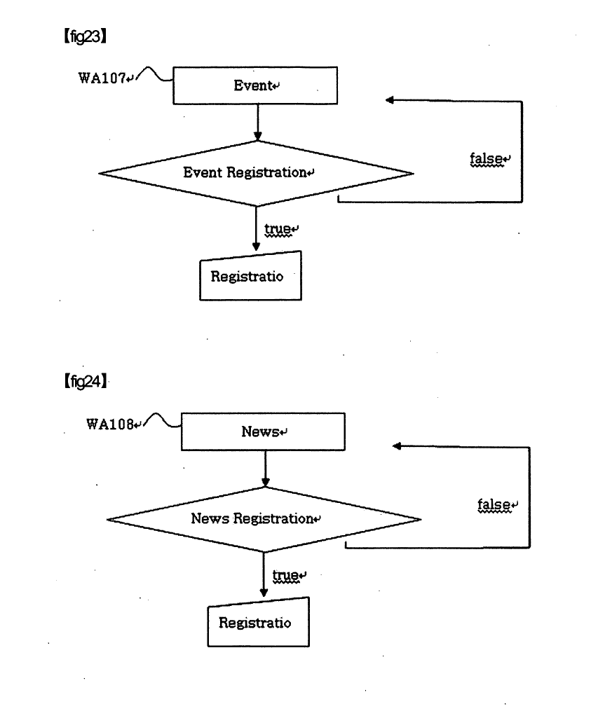

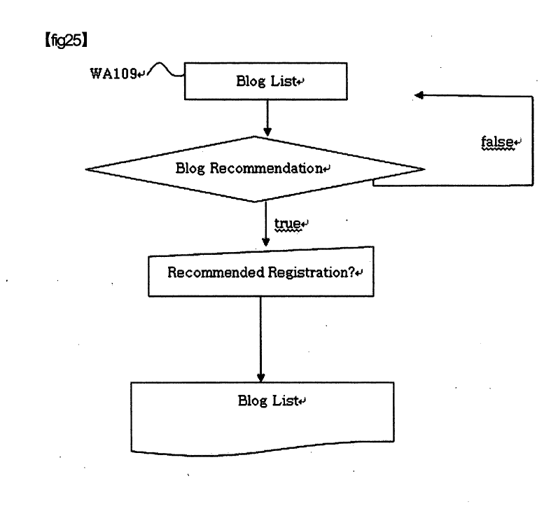

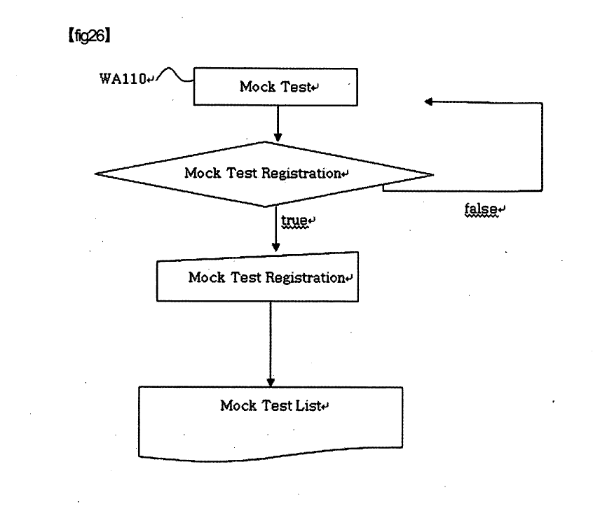

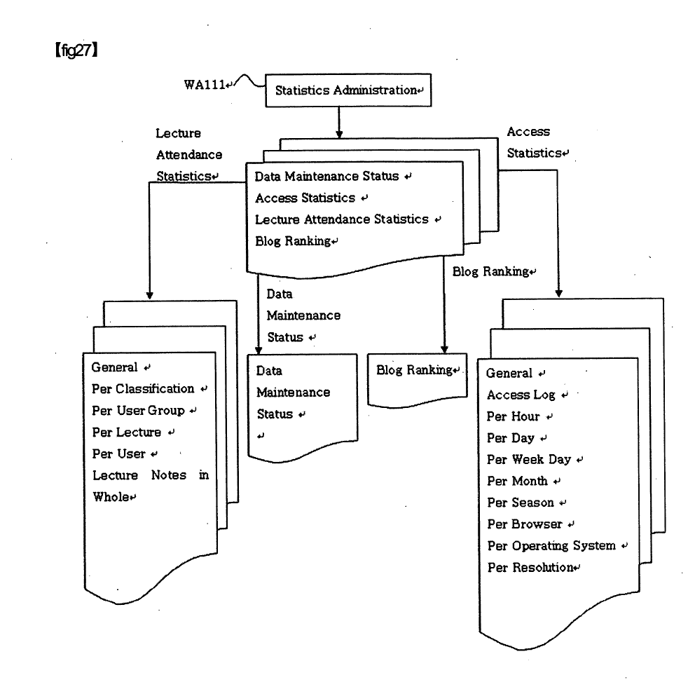

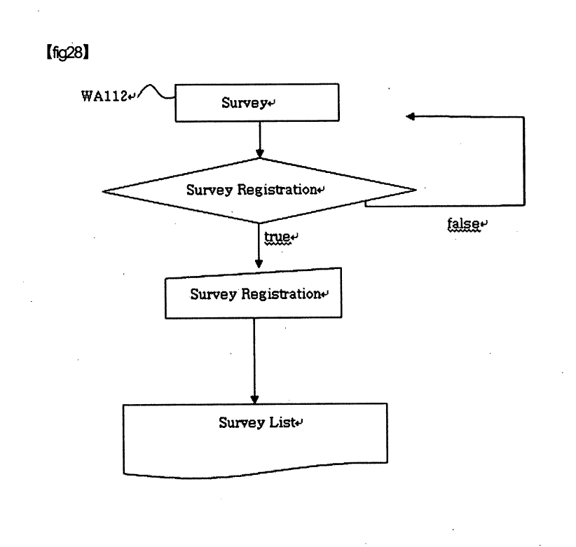

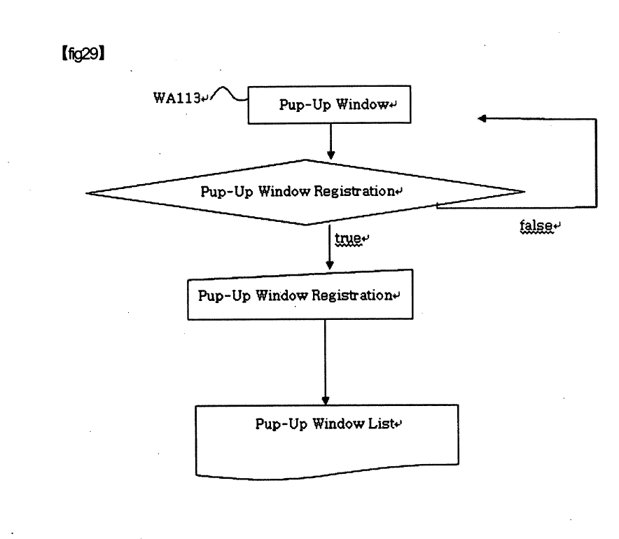

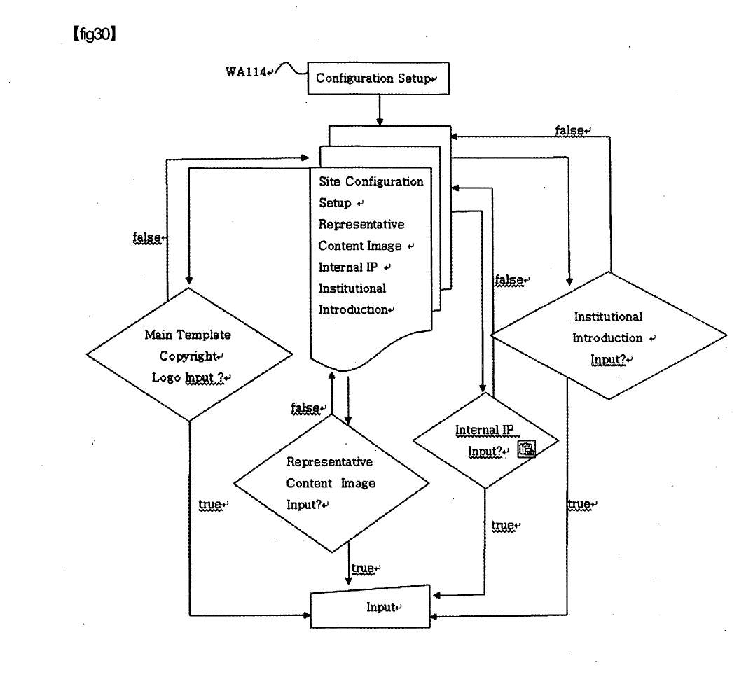

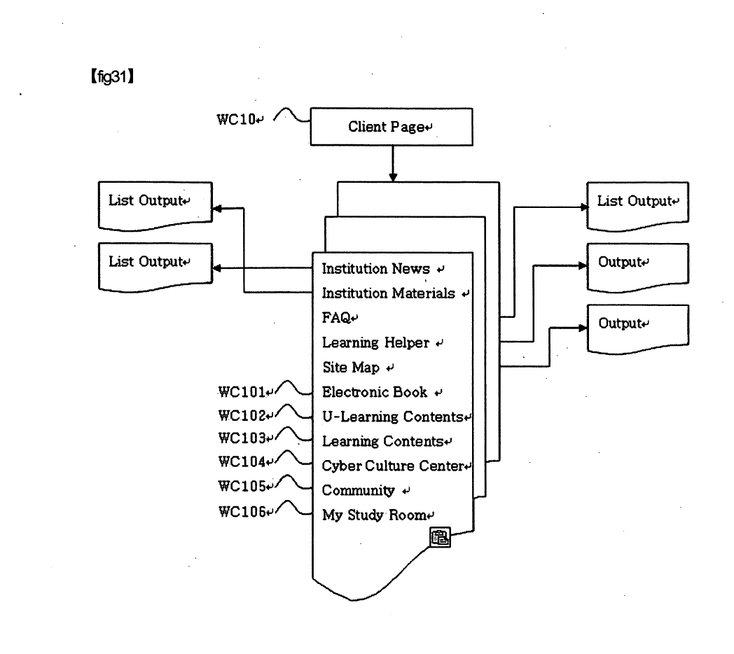

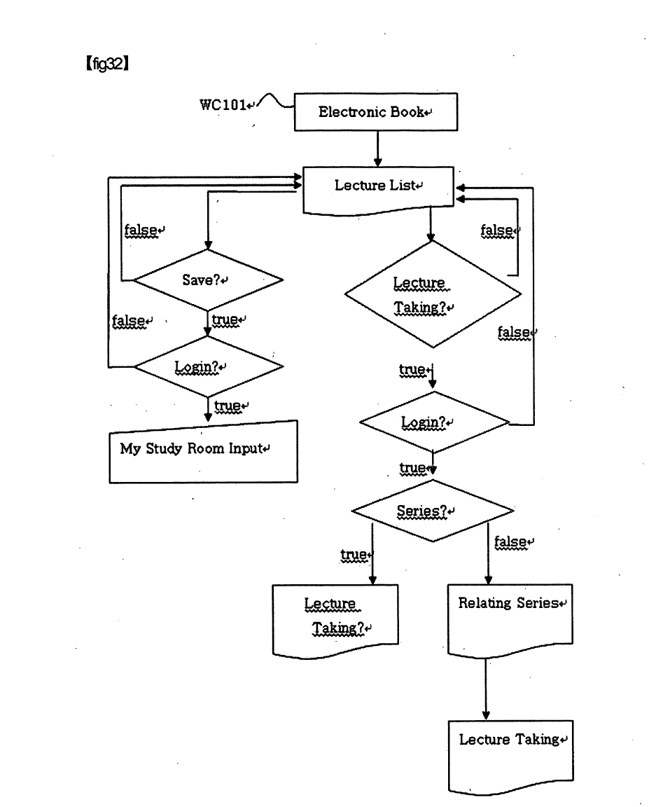

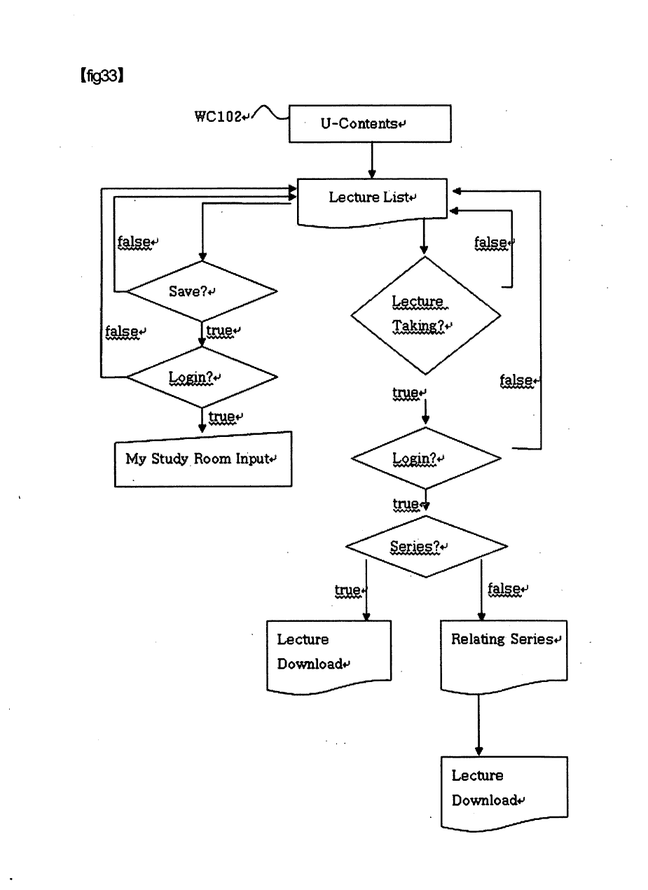

The FIG. 3 illustrates a mobile version page, which is divided into such categories as LMS Installing Method, Learning Method, Lecture Download, etc., and is comprised to download the contents of the fields classified according to the standard of classification system into Encyclopedia, Folk Literature, Social Science, Bibliography, Museology, Philosophy, Pure Science, Library and Information Science, Newspaper, Descriptive Science, and so forth, thereafter hearing the lecture in point.

FIG. 4 illustrates a web version of ULCMS for the class administration, which is divided into such contents as Class List, Completed Class List, Diary, Album, Bulletin Board, Visitors' Book, etc.

FIG. 5 illustrates a PDA ULCMS main page, where WEB ULCMS main page is logged in for the Main Page Login, and the Main Page Login displays the Homepage Administrating Page (WA10) for the administrator and the Homepage Administrating Page (WA10) for the general user, and Logout shifts the screen back to the initial screen.

FIG. 6 illustrates the Homepage Administrating Page shown in FIG. 5, comprising Menu Administration (WA100), Quick Menu Administration (WA101), Content administration (WA102), Membership Administration (WA103), Bulletin Board Administration (WA104), User recommending Material (WA105), Desired Material (WA106), Events (WA107), News (WA108), Blog (WA109), Mock Test (WA110), Statistics Administration (WA111), Survey (WA112), Pup-Up Window (WA113), Configuration Setup (WA114), and so forth.

FIG. 7 illustrates a flowchart for the Menu Administration (WA100), where the user selects from the menu Input and inputs if so desired, or Amend and amends if so desired, and Order Reverse and reverses the order if so desired, then to end (WA100).

FIG. 8 illustrates a flowchart for Quick Menu Administration (WA101), where the user selects from the menu Input and inputs if so desired, or Amend and amends if so desired, and Order Reverse and reverses the order if so desired, then to end (WA101).

FIG. 9 illustrates a flowchart for Content administration (WA102), which is divided into Category Administration (WA1021), Form Administration (WA1022), Player Administration (WA1023), Content Administration (WA1024), and Series Administration (WA1025).

FIG. 10 illustrates a flowchart for the Category Administration (WA1021) shown in FIG. 9, where the user selects from the menu Input, Amend, or Shift and, in case of input, judges on Manual Input or File Input and inputs manually or inputs a file, then to end (WA1021) and, in case of amendment or shift, amends or shifts, then to end (WA1021).

FIG. 11 illustrates a flowchart for Form Administration (WA1022) shown in FIG. 9, where the user selects from the menu Input or Amend and, in case of input, inputs, and, in case of amendment, amends, then to end (WA1022).

FIG. 12 illustrates a flowchart for Player Administration (WA1023) shown in FIG. 9, where the user selects from the menu Input or Amend and, in case of inputs, inputs, and, in case of amendments, amends, then to end (WA1023).

FIG. 13 illustrates a flowchart for Content Administration (WA1024) shown in FIG. 9, comprising Search (WA10244), Input/Amend (WA10242), File Extraction (WA 10243), and Class Registration & Waiting (WA10244).

FIG. 14 illustrates a flowchart for Search (WA10241) shown in FIG. 13, where the user judges on whether it is a search or not and, in case of search, outputs a Search List Output.

FIG. 15 illustrates a flowchart for the Input/Amend (WA10242) shown in FIG. 13, where the user judges on whether it is Input or Amend and, in case of inputs, carries out inputs and, in case of amendments, amendments, then to end.

FIG. 16 illustrates a flowchart for the File Extraction (WA10243) shown in FIG. 13, where the user judges on whether it is a file extraction or not and, in case of file extraction, extracts the file.

FIG. 17 illustrates a flowchart for the Class Registration & Waiting (WA10244) shown in FIG. 13, where the user judges on whether it is a registration or waiting and, in case of waiting, carries out waiting and, in case of registration, extracts.

FIG. 18 illustrates a flowchart for the Series Administration (WA1025), shown in FIG. 9, where the user judges in the Input/Amend step on whether it is Input or Amend and, in case of inputs, inputs and, in case of amendments, amends, then to end (WA 1021).

FIG. 19 illustrates a flowchart for the Membership Administration (WA103) shown in FIG. 6, where the user judges in the Input/Amend/Order Reverse step on whether it is inputs, amendments or order Reverse and, in case of Input, carries out inputs, and, in case of Amend, carries out amendments, then to end.

FIG. 20 illustrates a flowchart for the Bulletin Board Administration (WA104) shown in FIG. 6, where the user judges in the Input/Amend step on whether it is inputs or amendments and, in case of Input, carries out inputs, and, in case of Amend, carries out amendments, then to end.

FIG. 21 illustrates a flowchart for the User Recommending Material (WA105) shown in FIG. 6, where the user judges on whether it is a waiting or registration and, in case of Waiting, carries out waiting and, in case of Registration, carries out the registration, then to end.

FIG. 22 illustrates a flowchart for the Desired Material (WA106) shown in FIG. 6, which makes out a Desired Material List.

FIG. 23 illustrates a flowchart for the Events (WA 107) shown in FIG. 6, where the user judges in the Event step on whether it is an event registration or not and, in case of event registration, registers the event.

FIG. 24 illustrates a flowchart for the News (WA 108) shown in FIG. 6, where the user judges in the News step on whether it is news or not and, in case of news registration registers the news.

FIG. 25 illustrates a flowchart for the Blog (WA 109) shown in FIG. 6, where the user judges on whether if it is a blog recommendation or not and, in case of a blog recommendation, register the blog and makes out a Blog List.

FIG. 26 illustrates a flowchart for the Mock Test (WA 110) shown in FIG. 6 where the user judges on whether to register the mock test or not and, in case of mock test registration, registers the mock test, and makes out a Mock Test List.

FIG. 27 illustrates a flowchart for the Statistics Administration (WA111) shown in FIG. 6, where the user gets hold of Data Maintenance Status, Access Statistics, Lecture Attendance Statistics and Blog Ranking respectively and, in case of Data Maintenance Status and Blog Ranking, carries lecture attendance statistics and blog ranking and, in case of lecture attendance statistics, carries out General, Classified, User Groups, Lectures, Users, and Lecture Notes In Whole and, in case of Access Statistics, carries out General, Access Logs, Per Time, Per Day, Per Week Day, Per Month, Per Season, Per Browser, Per Operating System, and Per Resolution.

FIG. 28 illustrates a flowchart for the Survey (WA110) shown in FIG. 6, where the user judges in the Survey step on whether to register the survey or not, and, in case of survey registration, registers the survey, and makes out a Survey List.

FIG. 29 t illustrates a flowchart for the Pup-Up Window (WA113) shown in FIG. 6, where the user judges in the Pup-Up Window step on whether it is a pup-up window registration or not and, in case of pup-up window registration, registers the survey, and makes out a Pup-Up Window List.

FIG. 30 illustrates a flowchart for the Configuration Setup (WA114) shown in FIG. 6, where the user judges on Site Configuration Setup, Representative Content Image, Internal IP, and Institutional Introduction respectively, and, for the input of main template, copyright and logo, inputs Site Configuration Setup and, for the input of representative content image, inputs Representative Content Image and, for the input of internal IP, inputs Internal IP, and, for the input of institutional introduction, inputs Institutional Introduction respectively.

FIG. 31 illustrates a flowchart for the Client Page (WC10) shown in FIG. 5, where the user sets up a client page separately for Institutional News, Institutional Materials, FAQ, Learning Helper, Site Map, Electronic Book, U-Learning Content, Learning Content, Cyber Culture Center, Community, and My Study Room and outputs a list respectively.

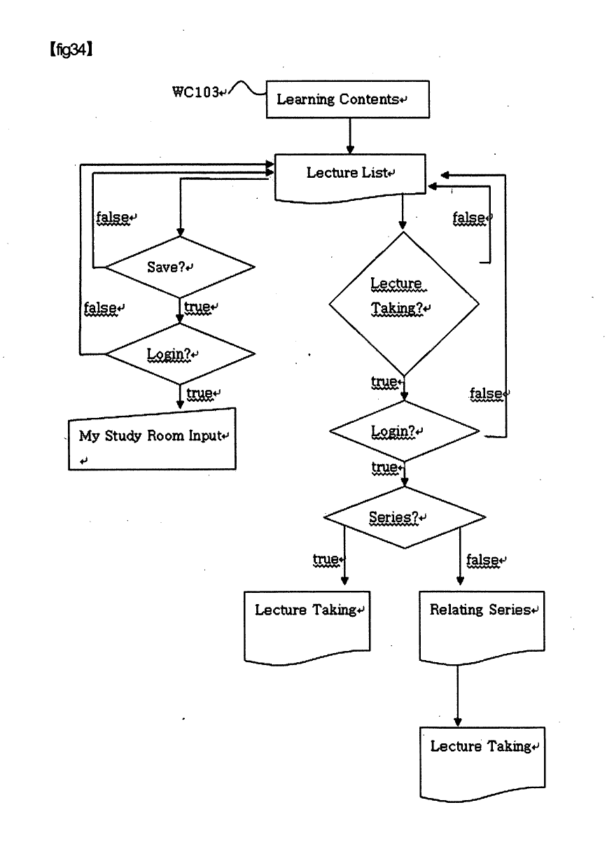

FIG. 32 illustrates a flowchart for the Electronic Book (WC101) shown in FIG. 31, where, in case of a Save to My Study Room in the Course Offering List step, the user logs in and inputs My Study Room and, if Lecture Taking and Login in the sequence turns into Series, the user takes the lecture in Lecture Taking and, if not, the user takes a lecture in Lecture Taking through the Relating Series.

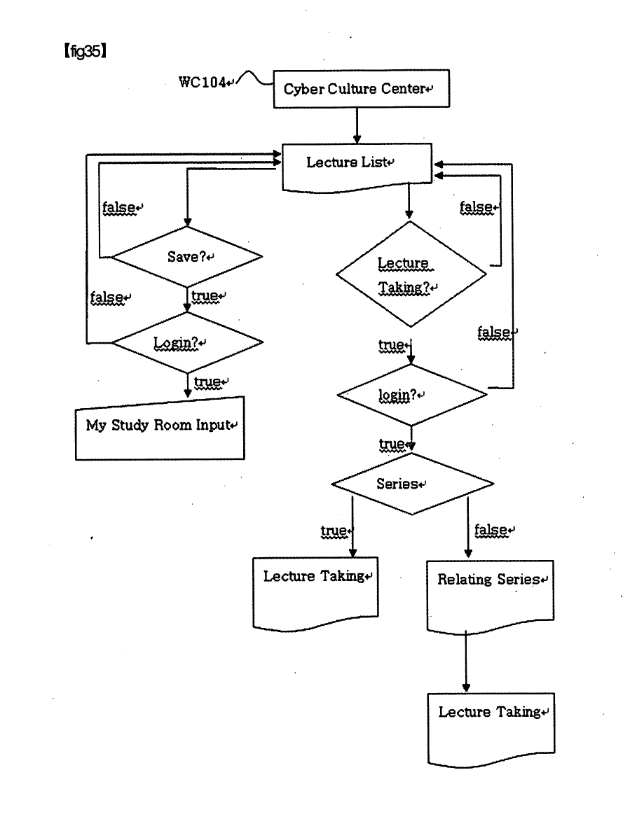

FIG. 33 illustrates a flowchart for the U-Learning Content (WC102) shown in FIG. 31, where, in case of a Save to My Study Room in the Course Offering List step, the user logs in and inputs Save to My Study Room and, if Lecture Taking and Login in the same sequence turns into Series, the user downloads the lecture and, if not, the user downloads the lecture through the Relating Series.

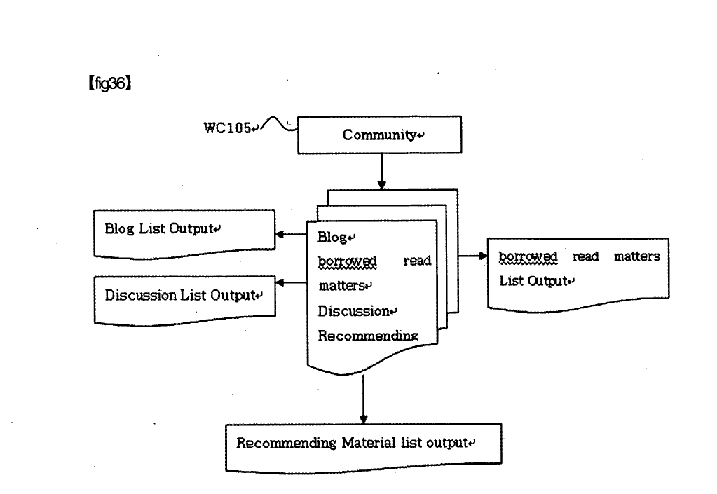

FIG. 34 illustrates a flowchart for the Learning Content (WC103) shown in FIG. 31, where, in case of a Save to My Study Room in the Course Offering List step, the user logs in and inputs My Study Room and, in case of Lecture Taking and Login in the same sequence turns into Series, the user takes a lecture in Lecture Taking and, if not, the user takes the lecture in Lecture Taking through the Relating Series.

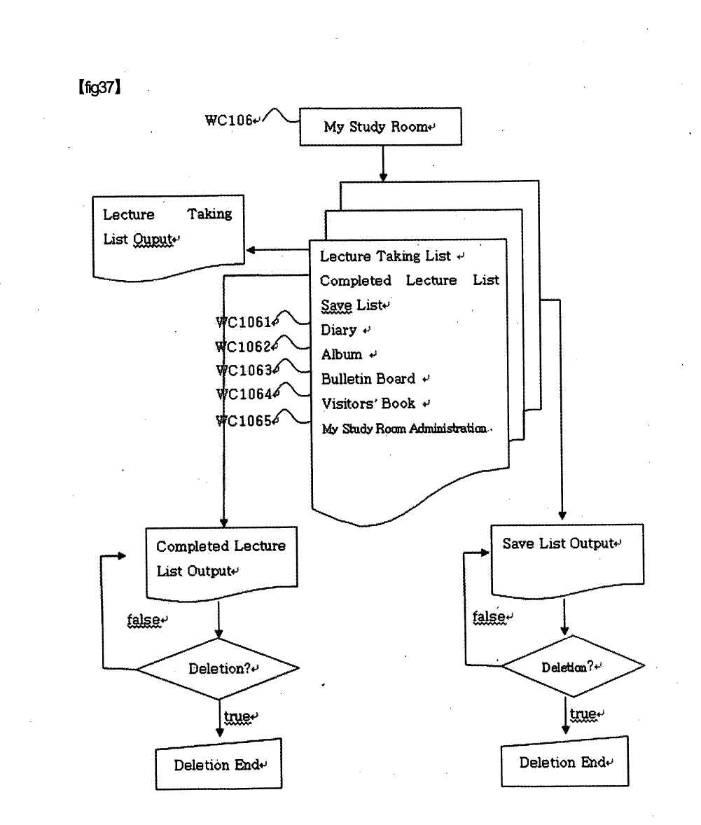

FIG. 35 illustrates a flowchart for the Cyber Culture Center (WC104) shown in FIG. 31, where, in case of a Save to My Study Room in the Course Offering List step, the user logs in and inputs My Study Room and, in case of Lecture Taking and Login in the same sequence turns into Series, the user takes a lecture in Lecture Taking and, if not, the user takes the lecture in Lecture Taking through the Relating Series.

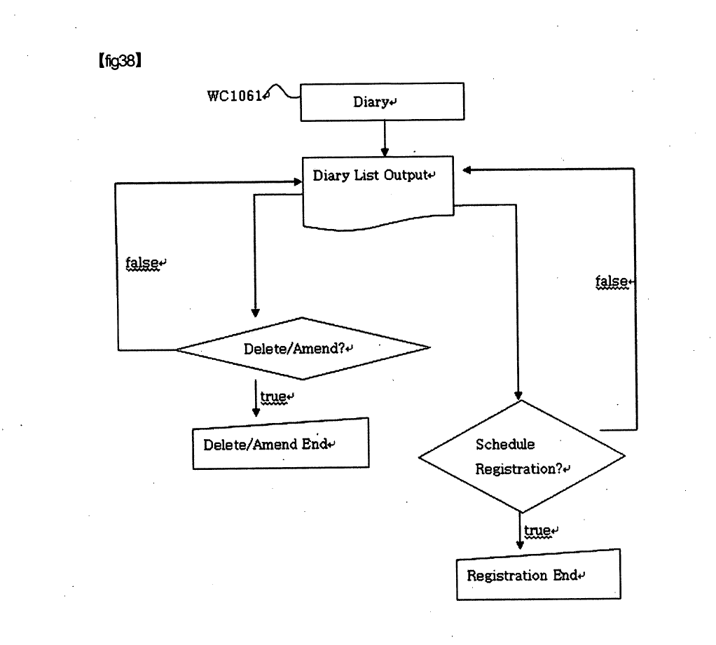

FIG. 36 illustrates a flowchart for the Community (WC105) shown in FIG. 31, where the user may output a list from any items of Blog, Data-I-Saw, Debate Corner, and Recommended Data respectively.

FIG. 37 illustrates a flowchart for the My Study Room (WC106) shown in FIG. 31, where the user outputs Current Lecture Taking List in the items of Lecture Taking List, Completed Lecture List, Save to My Study Room List, Diary, Album, Bulletin Board, Visitors' Book, and My Study Room and outputs Completed Lecture List, and, if a deletion is desirable, deletes to end.

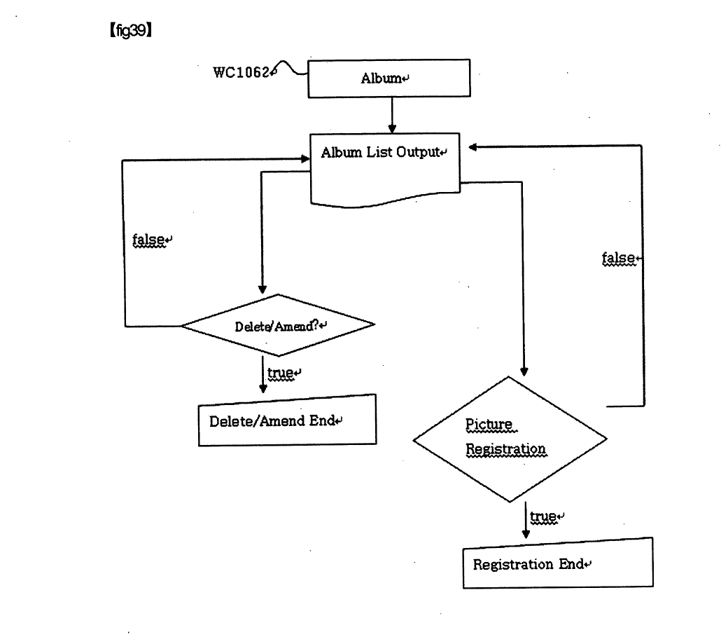

FIG. 38 illustrates a flowchart for the Diary (WC1061) shown in FIG. 37, where the user outputs Diary List and judges on whether it is a deletion or an amendment and, in case of deletion, carries out deletion and, in case of amendment, carries out an amendment, then to end.

Also, the user judges on whether to register a schedule or not and, in case of schedule registration, registers the schedule in Schedule Registration.

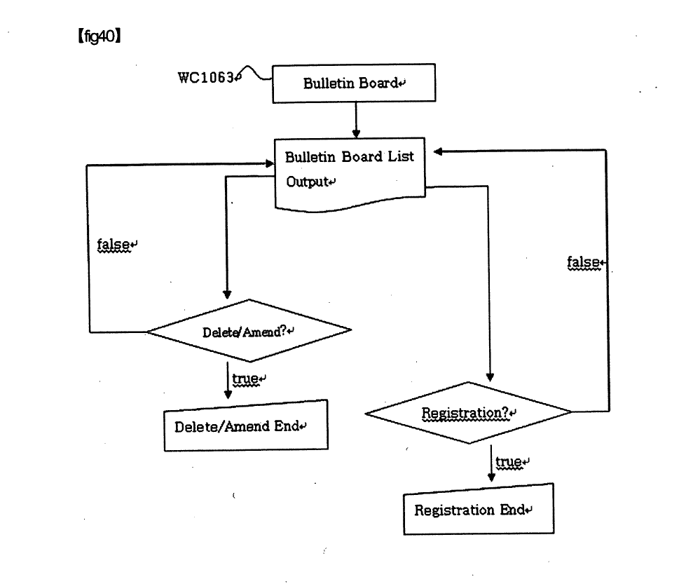

FIG. 39 illustrates a flowchart for the Album (WC1062) shown in FIG. 37, where the user outputs Album List and judges on whether it is a deletion or an amendment and, in case of deletion, carries out a deletion and, in case of amendment carries out amendment, then to end.

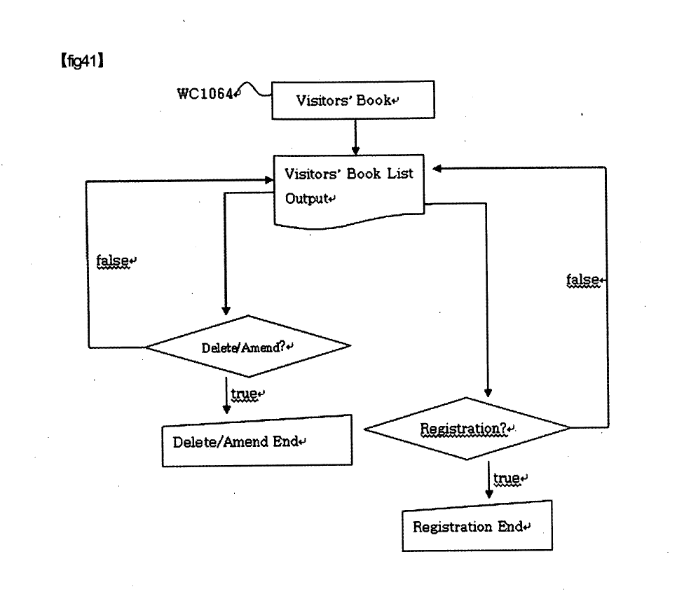

FIG. 40 illustrates a flowchart for the Bulletin Board (WC1063) shown in FIG. 37, where the user outputs Bulletin Board List and judges on whether it is a deletion or an amendment and, in case of deletion, carries out a deletion and, in case of amendment carries out amendment, then to end.

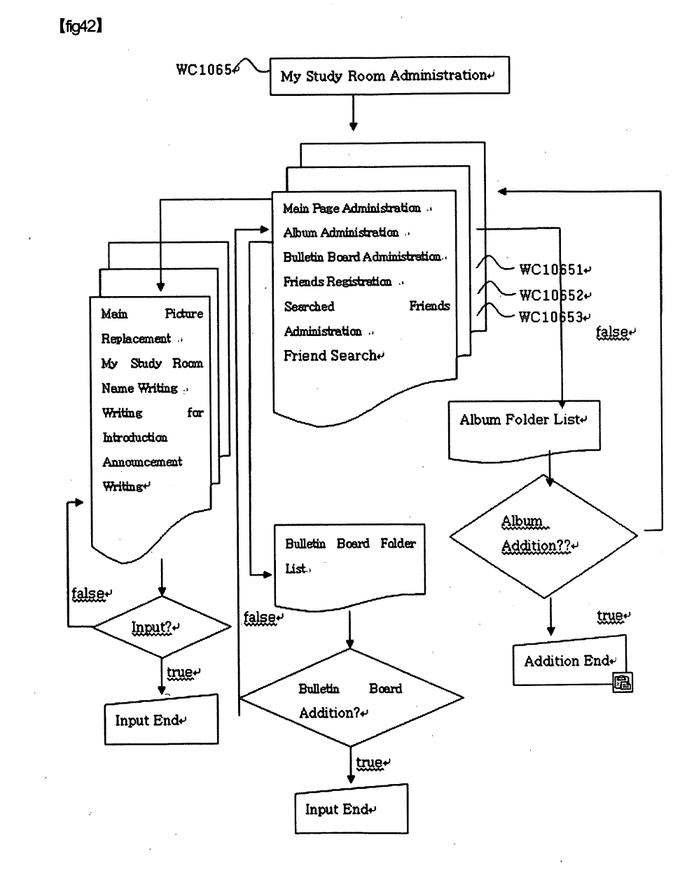

FIG. 41 illustrates a flowchart for the Visitors' Book (WC1064) shown in FIG. 37, where the user outputs Visitors' Book List and judges on whether it is an deletion or an amendment and, in case of deletion, carries out the deletion and, in case of amendment, carries out the amendment, then to end.

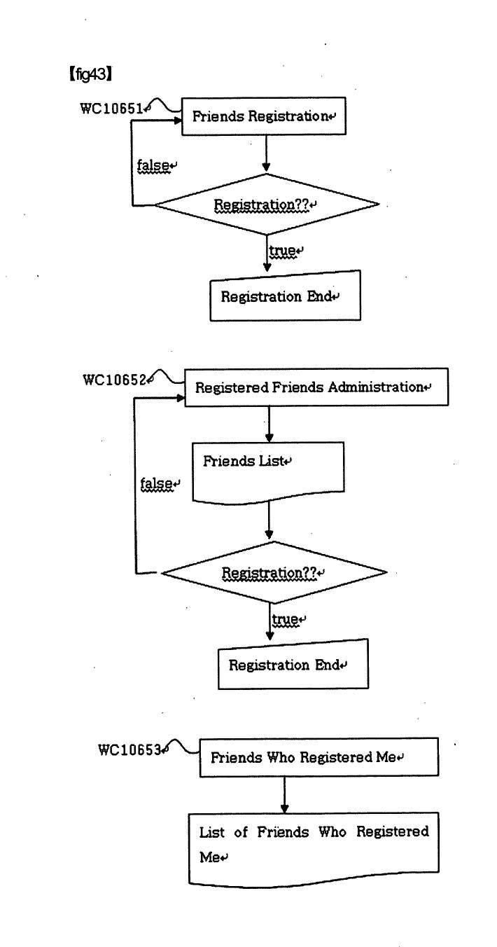

FIG. 42 illustrates a flowchart for the My Study Room Administration (WC1065) shown in FIG. 37, where the user, in Main Page Administration from the item list of Main Page Administration, Album Administration, Friend Registration, Registered Friend Administration, and Friend Search, the user carries out such items as Main Picture Replacement, Writing the Name of Room, Writing for Introduction, and Announcement and, in case of input, inputs, then to end.

In the Bulletin Board Folder List, the user judges on whether to add a bulletin board or not and, in case of an addition, adds a bulletin board, then end the input.

In the Album Folder List, the user judges on whether to add an album and, in case of an addition, adds an album and ends the addition.

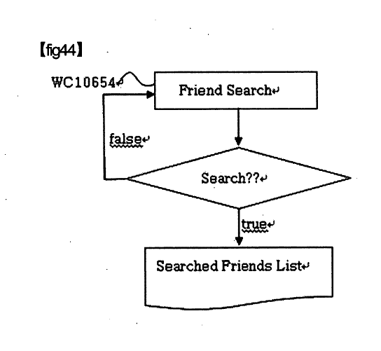

FIG. 43 illustrates a flowchart for the Friend Registration (WC1065) and Registered Friend Administration (WC10652) shown in FIG. 42, where, in the Friend Registration step, the user, in case of registration, registers, then to end and, in the Friend List, judges on whether to register or not and, in case of registration, registers, then to end.

FIG. 44 illustrates a flowchart for the Friend Search (WC10653) shown in FIG. 42, where the user, in case of a friend searched in the Friend Search, makes out a Searched Friend List.

The present invention as described in the above brings about an effect that it not only modularizes various index screens so that the design skin can be altered in the administrator's mode without a separate customizing, but also, because the main category can be organized into a field that is not fixed but variable, makes it possible for the administrator to alter the main category accordingly to the institutional peculiarities.

Also, the present invention brings about a royal welcome from the user to the effect that it not only applies LCMS (Learning Content Management System) and LMS (Learning Management System) to a physical support (wired/wireless internet, Mobile, PDA, DMB, PSP, etc.) so that the user may use and administrate the content, but also applies it to combine with the personal mini homepage (blog).

Further, the present invention brings about a further effect that, in case where the content is driven in such physical support as Mobile, PDA, DMB, PSP, etc., it provides a device of interface for the respective physical support irregardless of the kind of physical support in order to heighten the accessibility to the content, and in case where a wired/wireless internet is approached with Mobile, PDA, DMB, PSP, etc., it is comprised to download the content through USB without a separate telecommunicative link.

Further more, the present invention brings about many other effects to the extent that it may not only adopt and administrate any form of contents, integratively search any form of contents, and strengthen interfacing by the application of various skin modules, but also be able to contribute to the base enlargement for the wired/wireless unity content administration infrastructure and carry out the function of wired/wireless unity learning contents solution under the civil initiative that meets the age of U-Korea.

What is claimed is:

1. A content unity control method for using signal system comprising:
the 1st step for the membership application or the login with an authorized personal number;
the 2nd step for the user to search such data as e-book, u-learning, e-learning, cultural contents, etc. that he wants or for the user to go through a route to obtain data to use them;
the 3rd step for the e-book unity search (drive in a single interface) and its use;
the 4th step for the user, in case of u-learning, to access in the web and connect such physical wireless support as Mobile, PDA, DMB, PSP, etc. to the computer, and get downloading of the content to be used, thereafter shifting to the wireless device to use it;
the 5th step for accessing through URL in such physical wireless support of itself as Mobile, PDA, DMB, PSP, etc., thereafter to use it by getting downloading or by streaming;
the 6th step for using data to use through the web in case of e-learning or cultural content;
the 7th step for using the data co-existing in both e-learning and u-learning;
the 8th step for the composition of the web screen and the screen of the device of such physical support of itself as Mobile, PDA, DMB, PSP, etc. and the simultaneous provision;
the 9th step for the administration of the lecture notes taken by the user;
the 10th step for the combination of the course administration system with the blog for the provision of a user's personal cyber study room to use it;
the 11th step for showing the points accumulated according to the user's frequency of use, the user's level upgraded accordingly to the points accumulated, and the user's rank among all the users;
the 12th step for the provision of the data obtained in the above 11th step for various events;
the 13th step for using the community screen for the activation of the users;
the 14th step for applying for the desirable data in the web;
the 15th step for altering the skin of the main screen in the administrator's page without a separate customizing and modularizing various skins;
the 16th step for the unity control of the contents of such physical support as wired/wireless internet, Mobile, PDA, DMB, PSP, etc.;
the 17th step for developing, storing, and maintaining contents in the usable object unit so that the already developed content can be reused;
the 18th step for providing adaptable contents suitable for the user's characteristics;
the 19th step for maintaining the record information on the users as an operating system for administrating the users and transmitting the contents;
the 20th step for directly setting up a level of mock test suitable for the user; and
the 21st step for loading a function of survey for the collection of necessary data.

2. A content unity control method for using signal system as claimed in claim 1 characteristic of being able to download contents without a separate telecommunicative link in an approach through the wired/wireless internet with such a terminal device as Mobile, PDA, DMB, PSP, etc.

3. A content unity control method for using signal system as claimed in claim 1 characteristic of being able to modularize various skins of the index screen.

4. A content unity control method for using signal system as claimed in claim 1 characteristic of being able to produce the administrator's page of the main category.
